(19) United States
(12) Patent Application Publication
(10) Pub. No.: US 2026/0038172 A1
(43) Pub. Date: Feb. 5, 2026

(54) Systems and methods for automatically generating designs

(71) Applicant: Canva Pty Ltd, Surry Hills (AU)

(72) Inventors: Dadallage Amila Ruwansiri SILVA, Melbourne (AU); Raz FRIMAN, Woronora Heights (AU)

(73) Assignee: Canva Pty Ltd, Surry Hills (AU)

(21) Appl. No.: 19/277,639

(22) Filed: Jul. 23, 2025

(30) Foreign Application Priority Data
Jul. 30, 2024 (AU) 2024205224

(51) Int. Cl. G06T 11/60; G06F 40/40

(52) U.S. Cl. CPC G06T 11/60; G06F 40/40

(57) ABSTRACT

Described herein is a computer implemented method, a system and non-transitory computer readable memory for automatically generating a design. The method includes receiving an input prompt for generating the design and generating a design background based at least on the input prompt and a seed design template. The method further includes generating design text based at least on the input prompt; generating a design record including an identifier of the generated design background and the generated design text; and causing the design to be displayed on a client device, the design rendered based on the design record.

### CROSS REFERENCE TO RELATED APPLICATION

This application is a U.S. Non-Provisional Application that claims priority to Australian Patent Application No. 2024205224, filed Jul. 30, 2024, which is hereby incorporated by reference in its entirety.

### TECHNICAL FIELD

Aspects of the present disclosure are directed to systems and methods for automatically generating designs.

### BACKGROUND

Computer applications for creating and working with designs exist. Some such applications may provide users with the ability to create designs in different formats. Generally speaking, such applications allow users to create a design by, for example, creating a page and adding design elements to that page. Such applications may provide a number of design templates in various design categories to aid users in creating designs.

Whilst computer tools for manually generating such designs exist, the generation of designs is generally time consuming and at times a complex task requiring the manual generation of text content and retrieval of suitable media content tailored to the design topic or theme.

Accordingly, there exists a need for more intelligent computer applications that can assist users in creating designs

### SUMMARY

Described herein is a computer implemented method for automatically generating a design, the method including: receiving an input prompt for generating the design; generating a design background based at least on the input prompt and a seed design template; generating design text based at least on the input prompt; generating a design record including an identifier of the generated design background and the generated design text; and causing the design to be displayed on a client device, the design rendered based on the design record.

Also described herein is a computer processing system including one or more computer processing units; and a non-transitory computer-readable medium storing instructions which, when executed by the one or more computer processing units, cause the one or more computer processing units to perform the computer-implemented method described above.

Also described herein is a non-transitory storage storing instructions executable by one or more computer processing units to cause the one or more computer processing units to perform the method described above.

### BRIEF DESCRIPTION OF THE DRAWINGS

In the drawings:

FIG. 1 is a diagram depicting an example network environment for performing various features of the present disclosure.

FIG. 2 is a block diagram of an example computer processing system.

FIG. 3 is a process flowchart depicting an example method for automatically generating a design in response to a user input.

FIG. 4 is a process flowchart depicting an example method for generating a background for the design.

FIG. 5 is a process flowchart depicting an example method for producing a mask.

FIG. 6 is a process flowchart depicting an example method for generating text content for the design.

FIG. 7 is a process flowchart depicting an example method for generating and outputting the design.

FIG. 8 is an example user interface for receiving user input.

FIG. 9 depicts an example seed design template image and its background image.

FIG. 10 depicts an example mask image of the background image of FIG. 9.

FIG. 11 depicts an example refined mask image of the mask image of FIG. 10.

FIG. 12 depicts an example design background generated according to aspects of the present disclosure.

FIG. 13 is an example user interface displaying the automatically generated design according to some aspects of the present disclosure.

While the description is amenable to various modifications and alternative forms, specific embodiments are shown by way of example in the drawings and are described in detail. It should be understood, however, that the drawings and detailed description are not intended to limit the invention to the form disclosed. The intention is to cover all modifications, equivalents, and alternatives falling within the scope of the present invention as defined by the appended claims.

### DETAILED DESCRIPTION

In the following description, numerous specific details are set forth to provide a thorough understanding of the present invention. It will be apparent, however, that the present invention may be practiced without these specific details. In some instances, well-known structures and devices are shown in block diagram form to avoid unnecessary obscuring.

As discussed above, computer applications for creating and managing designs exist. Such applications may provide mechanisms for a user to create a design, edit the design by adding content to it, and output the design in various ways (e.g. by saving, displaying, printing, publishing, sharing, or otherwise outputting the design). As also discussed above, such applications may provide a user with the ability to create and manage designs of different formats-such as cards, posts, posters, presentations, documents, etc.

As further discussed above, many scenarios arise in which a user may wish to create a design, for example, to present on a topic. At a general level, creating a design involves a user first selecting a design template. Generally speaking, a design template includes a plurality of customizable/placeholder elements, such as text boxes, image boxes, shapes, banners, borders, colour themes and the like, which are configured to receive design elements from the user. Design templates may thus provide a structure to position the content of a design for display. Some computer applications may include different types of design templates suitable for different types of designs—for example, it may include design templates for presentations, design templates for posters, design templates for invitation cards, design templates for social media posts, etc.

Depending on the type of design the user wishes to create, the user may select a design template from the available templates suitable for that design type and then customize that design template by adding design elements to the design template. The design elements include, for example, text content (e.g. a sequence of one or more characters) and shape content. Shape content may include media content (e.g., images, videos, audio clips) and fill content (e.g., shapes in a solid colour or colour gradient). The user then manually deletes one or more placeholder elements, adds one or more placeholder elements, moves one or more placeholder elements around, and adds design elements to the placeholder elements until the user is satisfied with the resulting design.

Once the user has selected a template, conventionally, the user is still required to manually generate text content, and review/retrieve shape content to populate such a selected template. This can be a cumbersome and a time intensive exercise for a user and may often result in poorly created designs—e.g., designs that do not include suitable media content or fill content that matches the text content of the design.

To address this issue, several automatic design generation systems have been introduced recently. Examples of such systems include Stable Diffusion, DALL-E, COLE (by Microsoft®), etc. These systems are machine learning (ML) systems that receive an input textual prompt from a user, e.g., “create a cover image to announce a flower exhibition event” and automatically create one or more complete designs based on the textual prompt.

However, such automatic design generation systems perform sub-optimally for typography-focused designs—i.e., designs where text is placed on a background to emphasize the creative use of typography as a central visual element. That is, most existing automatic design generation systems either perform poorly in generating typography-focused designs, which require precise attention to aspects such as typography feature selection, contrast, and text placement, or require users to provide complex domain-specific details (e.g., font type, font size, position, etc.), which can be a challenge for those with limited design experience. For example, when Stable Diffusion and Dall-E are used to generate typography-focused designs they generate un-editable designs with poor typography-related aspects. Text diffuser and Glyph-By require users to explicitly pass complex details to the system, such as font types and text regions. Other systems such as COLE fail to adequately capture the nuanced characteristics of the intended typography. Some of these systems also produce designs with poor text contrast and text placement, which is an important quality factor for typography-focused designs.

Aspects of the present disclosure address one or more of these issues with existing automatic design generation systems for generating typography-focused designs, while keeping the required user input minimal. In particular, the disclosed embodiments propose a novel system for automated typography-focused design generation that creates new designs using textual prompts and design templates as inputs, ensuring adherence to the prompts while preserving the typography-related quality aspects of the input design templates.

To do so, the presently disclosed systems and methods refine the input textual prompt to automatically generate a background prompt and text for the design. The background prompt represents a suitable background for a design based on the textual prompt. Further, in some embodiments, the disclosed systems and methods process the input design template to decompose the background in the design template from any overlaid text placeholders and use this decomposed background together with the background prompt to generate a new design background. A design is then generated by combining this new design background with the text for the design that was automatically generated by the system based on the input textual prompt.

In some embodiments, a mask image that highlights areas in the design template on which text was placed is also generated. This mask image is then utilized together with the background image and the background prompt to generate a new background. In still further embodiments, the mask may be refined before it is utilized to generate the new background. The refined mask helps generate higher quality backgrounds with smoother transitions between the background and the overlaid text compared to existing systems.

To convert the input textual prompt into the background prompt, in some embodiments, a general-purpose large language model (LLM) may be utilized. In other embodiments, a smaller language model may be utilized. This smaller language model is tuned for the task of converting textual prompts into background prompts. Such fine-tuned models have reduced latency, allowing the system to generate designs much faster than existing systems.

As the designs generated by the techniques disclosed herein are created based on a design template (which includes individual design components), the generated designs are editable—that is, users may be able to edit individual elements in the design, e.g., by changing their positions, orientations, transparency, size, colour, etc. Further, users may be able to delete elements from the designs or add further elements to the design.

An editable design may, for example, be contrasted with a non-editable design. In the context of the present disclosure, a non-editable design is one in which individual design elements are not able to be selected, edited, or deleted. By way of example, non-editable designs include raster images such as jpeg, png, gif, and/or other raster format files that are generated by systems such as Dall-E, Stable Diffusion, etc.

Furthermore, while the techniques described herein provide for the generation of editable designs, further processing can (if desired) be performed to convert an editable design into a non-editable design (e.g. by processing the editable design to rasterise or flatten (or otherwise convert) the editable design into a non-editable version thereof).

The presently disclosed systems and methods require minimal user input-a (rough) textual input and an existing design template. This makes the solution attractive for users with limited design expertise.

Further, the designs generated by the disclosed systems and methods are visually harmonious and can be of high-quality as they are based on existing design templates. If the input design template is of high-quality, the design generated by the system is also of high quality. Further still, as the designs are based on existing design templates, this approach can generate designs with complex backgrounds and any existing typography, which is not possible with most existing automatic design generation systems.

These and other aspects of the present disclosure will now be described in detail with reference to the following figures.

### Design Templates

Design templates of various different design category types may be stored in a templates library. Each design template is stored in the library as a record. Design categories may include flyer, poster, social media post, social media story, logo, presentation and video, video thumbnail, invitation, etc. Additional and/or alternative categories are also possible. Each design template may be associated with various pre-set design attributes (such as colour, font, etc.).

In the present context, data in respect of a particular design template is stored in a design template record. A design template record defines certain design-level attributes and includes template metadata, template format data, and placeholder design elements. In the present example, the format of each design template record is a device independent format comprising a set of key-value pairs. To assist with understanding, a partial example of a design template record format is shown in table A below.

TABLE A
Example design record

| Attribute | Example |
|---|---|
| Template ID | “designId”: “abc123” |
| Template style | Vibrant |
| Dimensions | “dimensions”: {“width”: 1080, “height”: 1080} |
| Template type | “type”: “poster” |
| Template name | “name”: “Test Doc 3” |
| Design owner | “owner”: 12ab34cd |
| Background | “background”: {“assetID”: “M12345”} |
| Style | “styleAttributes”: {. . .} |
| Attributes | |
| Placeholder | “elements”: [{element l}, . . . {element n}] |
| element data | |

In this example, the design-level attributes include: a template identifier (which uniquely identifies the design template); a template style (which indicates a particular design style of the template), design dimensions (e.g. a default width and height of the design); a template type (e.g. an indicator of the type or category (or sub-category) of the design, which may be used for searching and/or sorting purposes); a template name (e.g. a string defining a default or user specified name for the design); a template owner (e.g. an identifier of a user or group that owns or created the design); style attributes (data indicating any style attributes of the design, such as a colour palette, a font palette, and/or other style attributes); and placeholder element data (discussed above). Additional and/or alternative design-level attributes may be provided, such as attributes regarding creation date, design version, design permissions, and/or other design-level attributes.

Various design-level attributes may be used as tags or terms (e.g., as metadata) for facilitating categorization and searching. For example, templates may be categorized and/or search based on template style, template type, template theme, template colour, template name, dimensions, and combinations thereof. Each of these tags or terms may be stored as metadata fields in the template record or in association with the template record.

Templates may also, or alternatively, be associated with other attributes (such as a keywords attribute) which can be used to store one or more keywords that can also or alternatively be used to organise and/or search/browse for templates.

As seen in table A, a design template includes placeholder elements of various types configured to receive a design element of a corresponding type. Placeholder elements may be positioned at (or configured to position source elements at) predetermined locations on a page, for example, at particular x and y coordinates and/or occupying particular ranges of pixels of a page having a predetermined resolution. Placeholder elements may also include style attributes for example, colours, fonts and the like which may be applied to design elements when populated into the placeholder element. A vast variety of design templates, placeholder elements, style attributes, and permutations thereof are possible. For example, in some embodiments, style attributes may be stored as placeholder element data of that template instead of (or in addition to) design level style attributes.

A template may include text placeholder elements (e.g., heading, subheading, body text etc.) and shape placeholder content elements (e.g., media items, shapes, etc.). Text placeholder elements may contain placeholder text and may be configured to receive corresponding text of a particular length (number of characters, words, or sentences) and/or in a particular form (paragraph, bullet points, or the like). Each of such text placeholder elements may also include one or more default style attributes that format the font including font type, font colour, and/or font size. Image placeholder elements may be configured to receive an image of a particular size, resolution, and/or aspect ratio. Shape placeholder elements may be configured to receive a shape or fill element, for example, a frame or banner. Shape placeholder elements may also include style attributes, for example, a fill or gradient of a particular colour. Any such style attributes may be default style attributes which may be overridden by the application of alternative style attributes

As one example, a design template may include placeholder elements of:
a pre-heading placeholder element that includes placeholder text of “Pre-heading goes here”, right justified, Calibri (light), 12 point font, black;
a heading placeholder element that includes placeholder text of “Put your main point or topic here”, bold, centred, Calibri, 18 point font, red;
a sub-heading placeholder element that includes placeholder text of “Briefly elaborate on what you intend to discuss”, underlined, left justified, Calibri, 16 point font, black;
a body text placeholder element that includes placeholder text of “Discuss your topic here”, left justified, Calibri, 14 point font, black;
an image placeholder element that includes a shape element for receiving an image of a particular range of resolutions which accommodate the placement of the text placeholder elements;
and a fill placeholder element that includes a shape element defining a banner with a fill of a particular colour or colour gradient.

Whilst the above example included a pre-heading, heading, sub-heading and single instance of body text, alternative templates with alternative text placeholder elements are possible. For example, a template may include multiple instances of placeholder body text or, alternatively, may include no placeholder text elements and include only one or more shape placeholder elements. Design templates may provide placeholder shape elements for receiving fills or images or may pre-populate the design template with images and/or shapes, for example, from a corresponding asset library.

In addition to the design level metadata fields mentioned previously, the design template may be stored along with additional semantic metadata. In some embodiments, this metadata describes the semantic meaning of the design template and the text fields of the corresponding text placeholder elements. The metadata may include textual descriptions of the design template and each text placeholder element within the design template. This metadata is used by the presently disclosed systems and methods to enhance the background prompt and/or design text. For example, it can be used to allow the ML systems to predict the meaning of each text placeholder element and provide text content/typography that matches the user intention. Additionally or alternatively, this metadata is used for determining approximate word counts that should be generated for each text placeholder, which may help avoid text overflow issues.

An example of the semantic metadata associated with a design template record is shown in the table below. This semantic metadata may be stored within the design template record or in another metadata data structure. If it is stored separately, the semantic metadata record includes an identifier of the design template it is associated with.

TABLE B
Example template text metadata

Design template ID: “abc123”
Description: “the main page for an Instagram post”
Text elements:
Text element 1: “location”: page index, group index, value “Title with three words”
Text element 2: “location”: “page index”, group index”, value: body text, with 4 words”

As seen in this table, the metadata for each text element includes its location which is defined by the page index and the group index value. The page index value indicates the reading order of the text element in the design template and the group index value indicates the reading order of the text element in a group design element. The reading order reflects an order in which text elements would be read by a viewer of the design. The embodiments described herein adopt a reading order consistent with written English language, that is left-to-right, top-to-bottom. The operations described may, however, be adapted for other reading orders—for example right-to-left, top-to-bottom (e.g. per Arabic, Hebrew, and other languages), top-to-bottom, right-to-left (e.g. per Japanese, Chinese, and other languages), or an alternative reading order (whether based on a particular language or not).

In the present embodiment, a page index value of 0 indicates a first text element in the reading order, a page index value of 1 indicates a second text element in the reading order, and so on.

In addition to the location values, the metadata record includes a description field that describes the nature of the template in plain text. In this example, the template is for a main page of an Instagram post. The metadata record also includes value fields for each text element in the template. The value fields indicate the nature of the text content of each text element. In this example, the template includes two text elements. The first text element includes a title and has three words, and the second text element includes body text and has four words.

### Example Systems

The techniques disclosed herein are described in the context of a digital design platform that is configured to facilitate various operations concerned with digital designs. In the context of the present disclosure, these operations relevantly include automatically creating a design based on user input. A digital design platform may take various forms. In the embodiments described herein the digital design platform is a client-server type platform (e.g., one or more client applications and one or more server applications that interoperate to perform the described techniques). The techniques described herein can, however, be performed (or be adapted to be performed) by a stand-alone digital design platform (e.g., an application or set of applications that run on a user's computer processing system and perform the techniques described herein without requiring server-side operations).

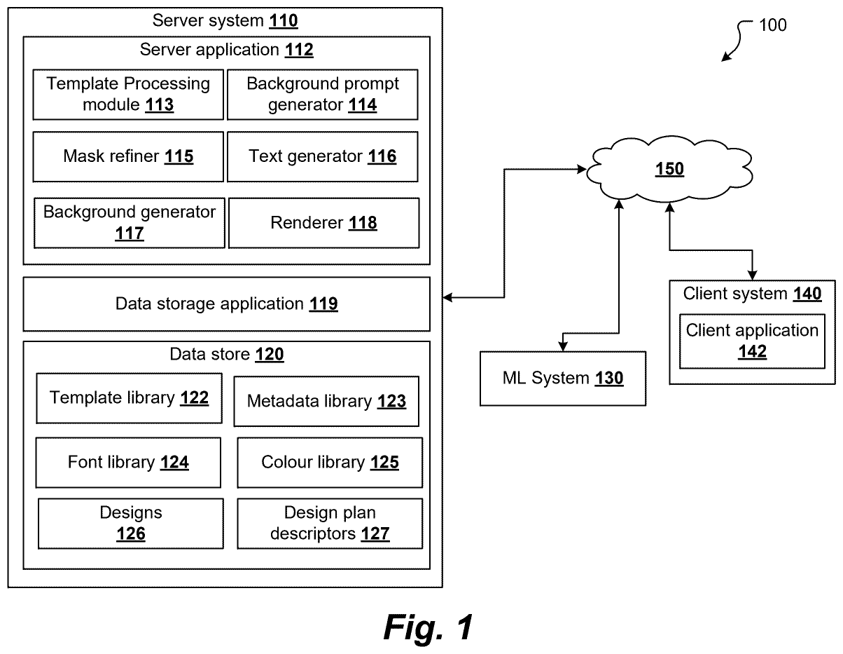

FIG. 1 depicts an example networked environment 100 in which various features of the present disclosure may be implemented. The networked environment 100 includes a server system 110, an ML system 130, and a client system 140, which operate together to perform the operations described herein.

The systems 110-140 communicate with one another via one or more communication networks 150 (e.g., the Internet). For example, the client system 140 communicates with the server system 110 via public internetwork, whereas the server system 110 may communicate with the ML system 130 via a local or public area network.

The server system 110 is a system entity that hosts one or more computer applications and/or content. The server system 110 may include one or more server computing systems or nodes for hosting a server application 112 and one or more storage devices (e.g., data store 120) for storing application specific data. An example of a server application hosted by the server system 110 includes a digital design application (e.g., Canva designs).

The server system 110 may execute to provide a client application endpoint that is accessible over the communication network 150. In some examples, the server system 110 is a web server, which serves web browser clients and receives and responds to HTTP requests. In another example, the server system 110 is an application server, which serves native client applications and is configured to receive, process, and respond to specifically defined API calls received from those client applications. The server system 110 may include one or more web server applications and/or one or more application server applications allowing it to interact with both web and native client applications.

While a single server architecture has been described herein, it will be appreciated that the server system 110 can be implemented using alternative architectures. For example, in certain cases a clustered architecture may be used where multiple server computing instances (or nodes) are instantiated to meet system demand. Communication between the applications and computer processing systems of the server system 110 may be by any appropriate means, for example direct communication or networked communication over one or more local area networks, wide area networks, and/or public networks (with a secure logical overlay, such as a VPN, if required). Conversely, in the case of small enterprises with relatively simple requirements the server system 110 may be a stand-alone implementation (i.e. a single computer directly accessed/used by the client).

The server application 112 (and/or other applications of server system 110), in conjunction with client application 142, facilitates various functions related to digital designs. These may include, for example, design creation, editing, organisation, searching, storage, retrieval, viewing, sharing, publishing, and/or other functions related to digital designs. The server application 112 may also facilitate additional, related functions such as user account creation and management, user group creation and management, and user group permission management, user authentication, and/or other server-side functions.

To perform the functions described herein, the server application 112 includes a number of software modules, which provide various functionalities and interoperate to automatically generate designs. These modules are discussed below and include: a template processing module 113; a background prompt generator 114; a mask refiner 115; a text generator 116; a background generator 117, and a renderer 118.

In the present embodiment, the template processing module 113 is configured to receive a design template (e.g., selected by a user or automatically selected by the design application) and decompose the design template into a background, overlaid design elements, and a mask.

The background prompt generator 114 is configured to receive the user textual prompt and generate a background prompt to generate a suitable background image for the design based on the textual prompt.

The text generator 116 is configured to receive the user textual prompt and generate textual content based on the textual prompt. The textual content replaces the text element placeholders in the design template.

The mask refiner 115 is configured to receive the mask decomposed from the design template by the template processing module 113 and further refine that mask. It may do so by highlighting text regions in the original design to make it suitable to generate a cohesive background using the background generator 117.

The background generator 117 receives the background decomposed by the template processing module 113, the background prompt generated by the background prompt generator 114 and the mask or refined mask generated by the mask refiner 115. It uses combinations of these inputs to generate a new background for a design.

The renderer 118 is configured to receive the textual content generated by the text generator 116 and the new background generated by the background generator 117 to generate one or more designs. The functionality of these modules will be described in detail later.

The server 110 may further include a data storage application 119, which is configured to receive and process requests to persistently store and retrieve, to and from data store 120, data relevant to the operations performed/services provided by the server application 112. Such requests may be received from the server application 112, other server environment applications, and/or (in some instances) directly from client applications such as 142.

The data storage application 119 may, for example, be a relational database management application or an alternative application for storing and retrieving data from data store 120. Data store 120 may be any appropriate data storage device (or set of devices), for example one or more non-transitory computer readable storage devices such as hard disks, solid state drives, tape drives, or alternative computer readable storage devices. Furthermore, while a single instance of data store 120 is described, server system 110 may include multiple instances of data storage.

The data store 120 stores data relevant to the operations performed/services provided by the server application 112. In particular, it stores asset libraries such as a template library 122 (e.g., a library of design templates records for various design categories), a template metadata library 123 (e.g., a library that stores metadata associated with the design templates stored in the template library), a font library 124 (e.g., a library of fonts and font palettes), a colour library 125 (e.g., a library of colours and colour palettes), and a designs library 126 (e.g., a library of designs automatically generated by the server system 110 in response to user inputs based on methods 3-7), user account data, design data, and/or other data relevant to the operation of the server application 112. In addition, the data store 120 may also maintain a cache that stores design plan descriptors 127 while candidate designs are being generated. Once candidate designs are generated and provided to the client device, the corresponding design plan descriptors 127 can be discarded, and the cache can be cleared.

The ML system 130 hosts one or more generative ML models that may be configured to generate outputs based on input prompts. In particular, the ML system 130 may be configured to receive an input prompt (e.g., a design content prompt) and generate text content for a design based on the input prompt.

In some embodiments, the ML system 130 may be a large language model (LLM) that is trained as a general purpose ML model that can be used to generate different types of text based outputs. In the present case, if a general purpose ML model is used, it is additionally trained to perform specific tasks. For example, the general-purpose ML model may be trained to generate text (e.g. design content described above) from a prompt. In other embodiments, the ML model may be a more specific model that is trained to generate the outputs described above.

Further still, in some examples, the ML system 130 may be associated with and owned by the same party that operates the server system 110. In this case, the ML system 130 may be part of the server system 110. In other examples, the ML system 130 may be owned or operated by a third party that is independent to the party that owns or operates the server system 110. Examples of third party LLMs include OpenAI's ChatGPT4, and Google's Bard.

The client system 140 may be a desktop computer, laptop computer, tablet computing device, mobile/smart phone, or other appropriate computer processing system. Client system 140 hosts a client application 142 which, when executed by the client system 140, configures the client system to provide client-side functionality/interact with server system 110 (or, more specifically, the server application 112 and/or other applications provided by the server system 110). Via the client application 142, and as discussed in detail below, a user can access and make use of the various techniques and features described herein—e.g., the user can input prompts and design templates to generate designs and view or preview designs. Client application 142 may also provide a user with access to additional design related operations, such as creating, editing, saving, publishing, sharing, designs and/or other design related operations.

The client application 142 may be a general web browser application which accesses the server application 112 via an appropriate uniform resource locator (URL) and communicates with the server application 112 via general world-wide-web protocols (e.g. http, https, ftp) over communications network 150. Alternatively, the client application 142 may be a native application programmed to communicate with server application 112 using defined API calls and responses. A given client system such as 140 may have more than one client application 142 installed and executing thereon. For example, a client system 140 may have a (or multiple) general web browser application(s) and a native client application.

The present disclosure describes various operations that are performed by server application 112 and client application 142. However, operations described as being performed by a particular application (e.g. server application 112) could be performed by (or in conjunction with) one or more alternative applications (e.g. client application 142), and/or operations described as being performed by multiple separate applications could in some instances be performed by a single application.

In the present example, server system 110 is configured to perform the functions described herein by execution of a software application (or a set of software applications)—that is, computer readable instructions that are stored in a storage device (such as non-transitory memory 210 described below) and executed by a processing unit of the system 200 (such as processing unit 202 described below). Similarly, client system 140 is configured to perform functions described herein by execution of software application 142 stored in a storage device and executed by a processing unit of a corresponding system.

The techniques and operations described herein are performed by one or more computer processing systems. By way of example, client system 140 may be any computer processing system which is configured (or configurable) by hardware and/or software—e.g. client application 142—to offer client-side functionality. A client system 140 may be a desktop computer, laptop computer, tablet computing device, mobile/smart phone, or other appropriate computer processing system. Similarly, the server application 112 is also executed by one or more computer processing systems (the server system 110).

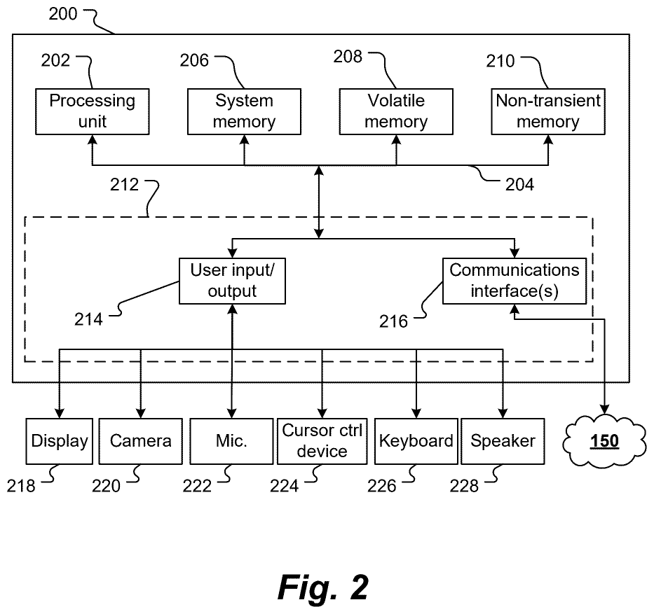

FIG. 2 provides a block diagram of a computer processing system 200 configurable to implement embodiments and/or features described herein. For example, systems 110 and/or 200 of FIG. 1 may be (or include) a computer processing system such as that shown in FIG. 2 (though alternative architectures are possible).

System 200 is a general purpose computer processing system. It will be appreciated that FIG. 2 does not illustrate all functional or physical components of a computer processing system. For example, no power supply or power supply interface has been depicted, however system 200 carries a power supply or is configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine readable storage (memory) devices, which store computer readable instructions, and/or data, which are executed by the processing unit 202 to control operation of the processing system 200. In this example, system 200 includes a system memory 206 (e.g. a BIOS), volatile memory 208 (e.g. random access memory such as one or more DRAM modules), and non-transitory memory 210 (e.g. one or more hard disk or solid state drives).

System 200 also includes one or more interfaces, indicated generally by 212, via which system 200 interfaces with various devices and/or networks. Other devices may be integral with system 200 or may be separate. Where a device is separate from system 200, the connection between the device and system 200 may be via wired or wireless hardware and communication protocols and may be a direct or an indirect (e.g. networked) connection.

Depending on the particular system in question, devices to which system 200 connects include one or more input devices to allow data to be input into/received by system 200 and one or more output devices to allow data to be output by system 200. Example devices are described below. However it will be appreciated that not all computer processing systems will include all mentioned devices, and that additional and alternative devices to those mentioned may well be used.

For example, system 200 may include or connect to one or more input devices by which information/data is input into (received by) system 200. Such input devices may, for example, include a keyboard, a pointing device (such as a mouse or trackpad), a touch screen, and/or other input devices. System 200 may also include or connect to one or more output devices controlled by system 200 to output information. Such output devices may, for example, include one or more display devices (e.g. a LCD, LED, touch screen, or other display devices) and/or other output devices. System 200 may also include or connect to devices which act as both input and output devices, for example touch screen displays (which can receive touch signals/input and display/output data) and memory devices (from which data can be read and to which data can be written).

By way of example, where system 200 is an end user device (such as system 140), it may include a display 218 (which may be a touch screen display), a camera device 220, a microphone device 222 (which may be integrated with the camera device), a cursor control device 224 (e.g. a mouse, trackpad, or other cursor control device), a keyboard 226, and a speaker device 228.

System 200 also includes one or more communications interfaces 216 for communication with a network, such as network 150 of FIG. 1. Via the communications interface(s) 216, system 200 can communicate data to and receive data from networked systems and/or devices.

System 200 may be any suitable computer processing system, for example, a server computer system, a desktop computer, a laptop computer, a netbook computer, a tablet computing device, a mobile/smart phone, a personal digital assistant, or an alternative computer processing system.

System 200 stores or has access to computer applications (which may also be referred to as computer software or computer programs). Such applications include computer readable instructions and data which, when executed by processing unit 202, configure system 200 to receive, process, and output data. Instructions and data can be stored on non-transitory machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example and referring to the networked environment of FIG. 1 above, server system 110 includes one or more systems 200, which run a server application 112. Similarly, client system 140 runs a client application 142. Application 142 is configured to display an input user interface (UI), e.g. on display 218. Server application 112 may communicate with client application 142 to display the input UI using the user interface module 134. The input UI provides a mechanism for a user to generate designs, for example, by searching for and selecting template designs, and providing textual prompts, and outputting designs by saving, publishing, or otherwise outputting the design. For example, a user may commence generating a design by entering a textual prompt and selecting a design template from the template library 122. The user may then view designs generated by the server system 110, edit the designs, and/or publish one or more of the designs.

In the present disclosure, the input UI provides a mechanism for a user to automatically generate a design by inputting a prompt for a design and to edit and output such designs. Various input UIs are possible. One example is graphical user interface (GUI), and the UI will be envisioned as a GUI in the following description. While a GUI is provided as an example, alternative input UIs are also possible. As another example, the input UI may be a command line interface type UI that a user can use to provide prompts, design templates or design template identifiers (e.g., file locations or other identifiers) that are to be used in the design generation. The UI also allows a user to access and cause other functionality described herein to be performed. By way of example, the UI may include a prompt input region, which can be used by a user to input a prompt. The UI may also include functionality to display design options to a user for selection, for example the display of candidates, explained further below.

### Example Methods

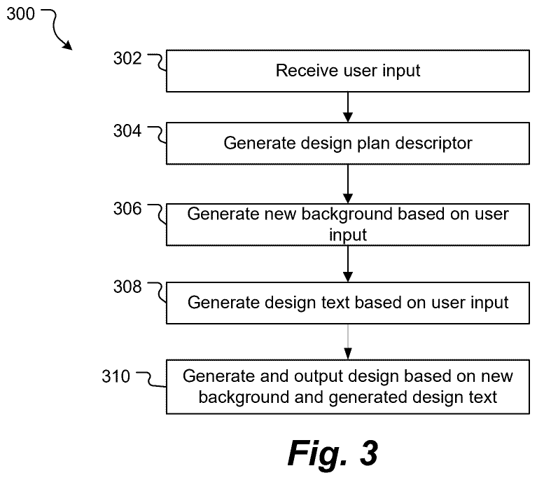

Turning to FIG. 3, a method 300 for automatically generating one or more candidate designs will be described. The operations of method 300 will generally be described as being performed by application 112 (and the various associated modules) running on system 110. The operations could, however, be performed by one or more alternative applications running on system 110 and/or one or more alternative computer processing systems.

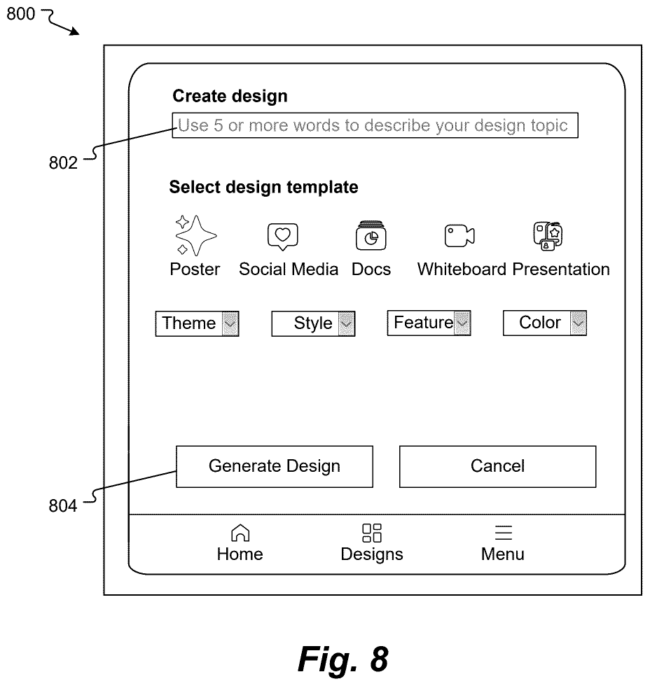

Application 112 may be configured to perform method 300 in response to detecting one or more trigger events. As one example, application 112 may communicate with application 142 (e.g. via network 150) to cause application 142 to display a user interface), e.g., user interface 800 displayed in FIG. 8. The UI 800 includes a prompt input region 802. The prompt input region 802 may include a text field with placeholder text, for example, of “Use 5 or more words to describe your design” or alternative text, which directs a user to input their prompt in this region 802.

In addition, the UI 800 includes a mechanism for the user to select a design template. The selected design template is referred to as a seed design template herein. Various mechanisms can be employed to allow a user to select the seed design template. In some examples, previews of various design templates may be displayed in the UI 800. Selection of any of the template previews causes the associated design template to be selected as a seed design template. The design templates may be organized based on various categories, such as document templates, whiteboard templates, presentation templates, social media templates, website templates, and so on. Further, in each category, the design templates may be arranged based on various sub-categories. For example, in the presentation category, the design templates may be organized based on sub-categories such as brainstorming, education, game, planner, etc. In the social media category, the design templates may be organized based on sub-categories such as posts, reels, stories, covers, ads, etc. Users may be able to further filter design templates in any category based on criteria such as format (e.g., square, portrait, 16:9, etc.); style (e.g., modern, minimalist, professional, elegant, etc.); theme (e.g., business, company, corporate, marketing, education, event, etc.); colour, etc. It will be appreciated that the filter criteria available for any given template category may be based on the given category. That is, the filter criteria can vary based on the selected template category.

The UI 800 further includes an interactive control, e.g., “generate design” control 804. The method 300 may commence when a user inputs a user prompt in the prompt input region 802, selects a seed design template, and then activates the interactive control 804.

In some embodiments, selection of a seed design template may not be required. In such cases, the server application 112 may automatically select a seed design template. This may be done in some instances based on the user prompt. For example, if the user prompt is “create a professional Instagram post for a bake-off event”, the server application 112 may automatically select a seed design template from the “Post” sub-category in the “Social Media” category. It may select the most popular or most used design template that has “elegant” in a style metadata field as the seed design template.

Other mechanisms for automatically selecting a seed design template are also possible. In one example, the user may separately provide criteria for the seed design template. For example, the UI 800 may provide categories, sub-categories, and/or style options (such as themes, colours, format, etc.) for the user to select from (e.g., via dropdown menus or other selectable controls) and may then automatically select a seed design template based on the selected criteria.

At step 302, a request for generating candidate designs is received at the server application 112. In one example, once the user activates the control 804, the client application 142 creates a request for generating one or more candidate designs and passes the user prompt along with the request to the server application 112. The user prompt may be in the form of a text string, for example, of 5 or more words. If the user has also selected a seed design template, the identifier of the seed design template is forwarded to the server application 112 along with the request. If the seed design template has not been selected by the user, any criteria for selecting the seed design template (if provided) is forwarded with the server application 112.

At step 304, the application 112 creates a design plan descriptor 127 for the received request. In particular, it may generate a unique design plan identifier and store the design plan identifier in the design plan descriptor 127 along with the user prompt received as part of the request. If the request also includes the seed design template identifier or criteria for the seed design template, this is stored in the design plan descriptor 127 along with the user prompt. An example design plan descriptor 127 at this stage is displayed below in table C—

TABLE C
Example design plan descriptor after step 304

| | |
|---|---|
| Design plan | 273278 |
| identifier | |
| User prompt | “Illustrative, underwater coral-reef |
| | themed Instagram post” |
| Seed design | abc123 |
| template ID | |

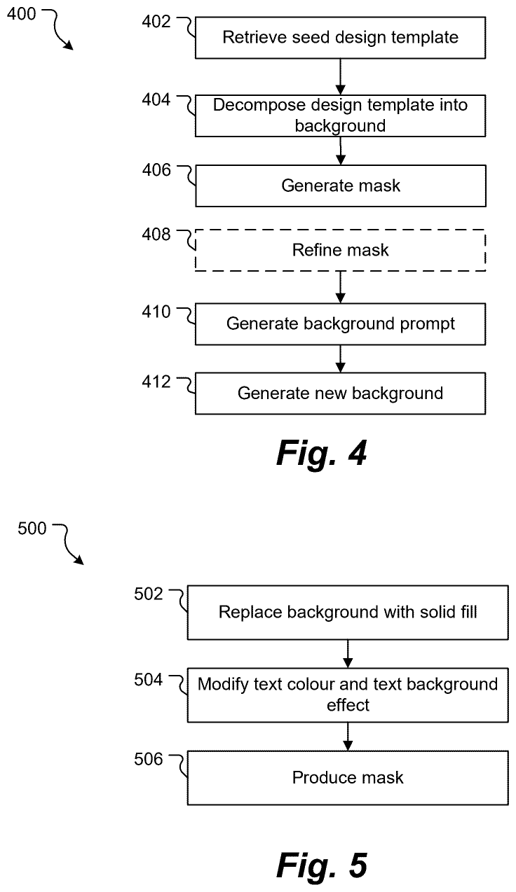

At step 306, the server application 112 generates a new design background based on the seed design template. This step is described in more detail with reference to FIG. 4. Once the new background is generated, it may be temporarily stored in the data store 120 in association with a unique identifier. The design plan descriptor may be updated at this stage to include the identifier of the new background.

An example design plan descriptor 127 at this stage is displayed below in table D—

TABLE D
Example design plan descriptor after step 306

| | |
|---|---|
| Design plan | 273278 |
| identifier | |
| User prompt | “Illustrative, underwater coral-reef |
| | themed Instagram post” |
| Seed design | abc123 |
| template ID | |
| Background ID | 23463298 |

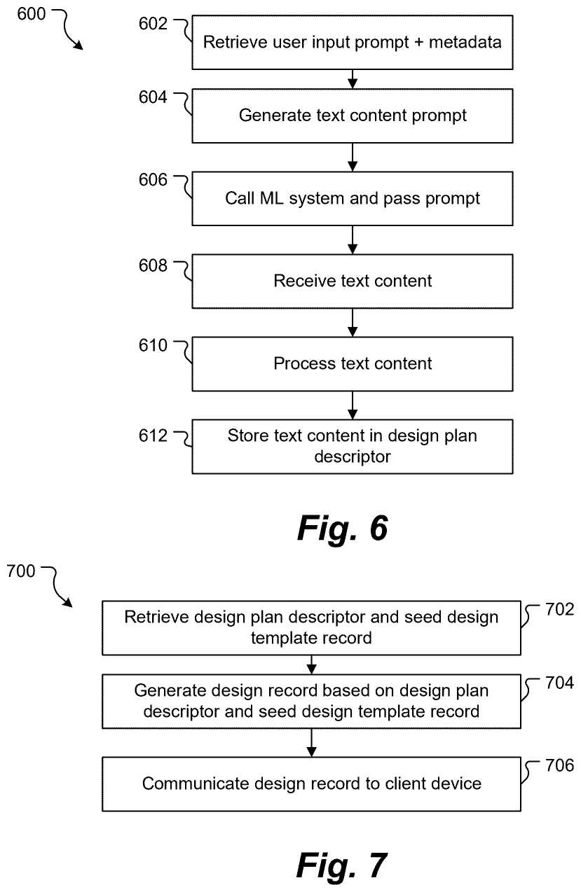

At step 308, the text generator 116 generates text content for the candidate design based on the user input and the seed design template. In some embodiments, to do so, the text generator 116 generates a second input prompt based on the user input and metadata associated with the seed design template and communicates this prompt to the ML system 130 along with a request for text for the design. The text generator 116 receives the text content from the ML system 130 and populates the design plan descriptor and in particular a text content field with the received text content. Method step 308 will be described in more detail with reference to FIG. 6.

An example design plan descriptor 127 at this stage is displayed in table E.

TABLE E
Example design plan descriptor after step 308

| | |
|---|---|
| Design plan | 273278 |
| identifier | |
| User prompt | “Illustrative, underwater coral-reef |
| | themed Instagram post” |
| Seed design | “abc123” |
| template ID | |
| Background | Undersea scene with fish and coral |
| prompt | reef |
| Background ID | 23463298 |
| Text content | Text0.0 - Abstract Art Exhibition |
| | Showcase |
| | Text1.0 - We are excited to launch a |
| | fresh new art exhibition |

The method 300, may then proceed to the step 310, where the one or more candidate designs are generated and communicated to the client system 140 for display thereon. At step 310, the application 112 inspects the design plan descriptor 127, retrieves the background and text content, applies style attributes such as the fonts and colours to the text content and transfers the text content to the new background generated at step 306 to create the design record. This step will be further outlined below, with reference to FIG. 7. Whilst method 300 is described sequentially, it is also possible to perform steps of the process in alternative orders.

Once a new design record is generated, it is communicated to the client device for display.

FIG. 4 is a flowchart illustrating an example method 400 for generating a new design background. The method 400 commences at step 402 where the template processing module 113 retrieves the seed design template. In case the seed design template identifier is present in the design plan descriptor 127, the template processing module 113 performs a look up with this identifier in the template library 122 and retrieves the corresponding design template record. Alternatively, if the seed design template identifier is not present in the design plan descriptor, it automatically selects a seed design template as explained previously and retrieves the record for that automatically selected seed design template from the template library 122.

At step 404, the seed design template is decomposed into a background and overlaid design elements. As described previously, a template record includes or is associated with a background and design element records. At this step, the template processing module 113 may remove all the design elements from the selected design template record and uses the remaining template record e.g., the background identifier and design dimensions) to render a rasterized image of the template record.

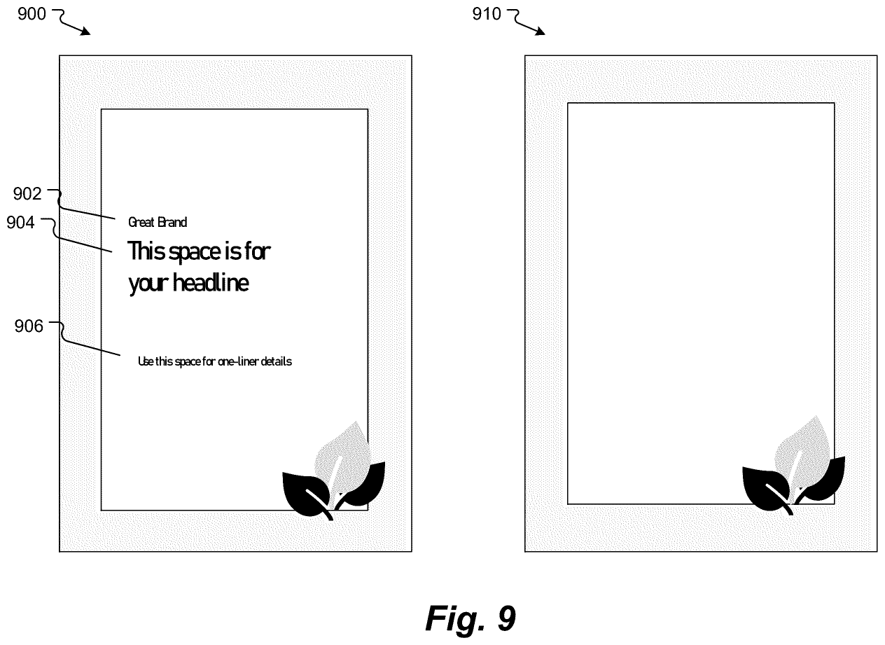

FIG. 9 illustrates a rasterised design template 900 (that may be generated based on a complete design template record) and a rasterized background 910 of design template (that is generated once all the design elements are removed from the design template record). As can be seen in FIG. 9, the rasterized design template 900 includes a background (the light grey border and the leaves at the bottom right corner) and one or more text design elements (e.g., the pre-header text element 902, a title text element 904, and a smaller text element 906 for body text). The background 910 includes only the background elements (i.e., the light grey border and leaves at the bottom right corner) without any overlaid design elements (i.e., elements 902-906). The rasterized background 910 is one of the outputs of this step.

At step 406, the template processing module 113 generates a mask image based on the seed design template 900. Generally speaking, a mask image is a greyscale image, which is typically used to control the visibility of different parts of a design. A mask image includes masked portions and highlighted portions. The masked portions cover areas of the design that can be changed during subsequent processing and the highlighted portions cover areas of the design that are to be left unchanged during subsequent processing. Mask images can be generated in various ways. One method for generating the mask image is illustrated in FIG. 5.

In particular, FIG. 5 is a flowchart illustrating an example method 500 for generating a text mask image. The method 500 commences at step 502, where the template processing module 113 replaces the background element in the design template record with a solid-coloured fill. In one example, the background element can be replaced with a solid black coloured fill.

Next at step 504, the template processing module 113 modifies the text elements in the design template record to change the font colour of the text elements to a colour that is contrasted from the colour of the background selected in the previous step. If the background colour is selected to be black, the colour of the font of each of the text elements in the design template record can be programmatically changed to a contrasting colour, such as white. Further, in some embodiments, a background effect may be applied to the text elements. In one example, the background effect may be the same colour as the font colour selected at this step.

At step 506, the template processing module 113 renders a rasterized image of the design template based on the updated design template record. This rasterised image is the mask image.

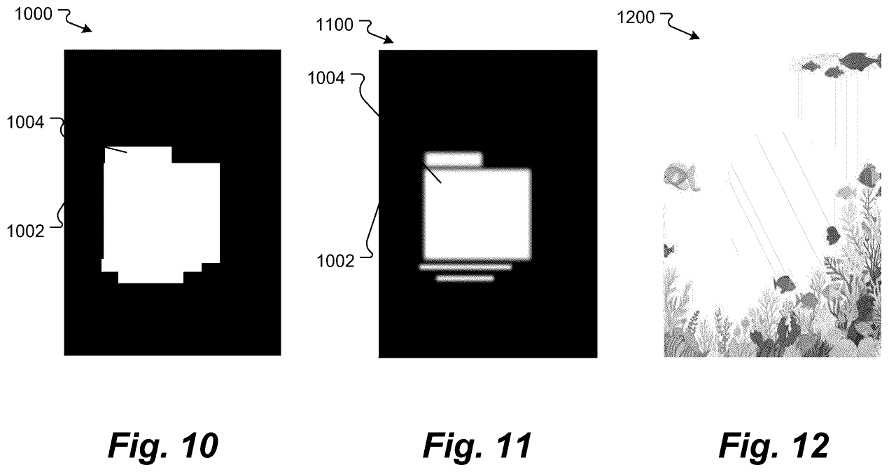

FIG. 10 shows an example mask image 1000 generated by method 500 for the design template 900. As can be seen from this mask image 1000, the masked portions 1002 include all areas of the design template 900 except the portions that included the text elements 902-906, which are the highlighted portions 1004. In this example, the pixels in the masked portions 1002 have a solid black colour or 0.0 pixel value and the pixels in the highlighted portions 1004 have a solid white colour or 1.0 pixel value.

Returning to FIG. 4, once the mask image 1000 is generated, the method proceeds to step 408, where the mask image 1000 is refined. This step is optional and depends on the technique used subsequently to generate the new background. In some embodiments, the new background is generated based on a technique called differential diffusion—in such cases, the refined mask may be generated. Differential diffusion utilizes an input image, a change map representing the desired change amount of each pixel in the input image and a text prompt. In particular, it generates a new image by applying changes to the input image based on the text prompt and the change map. Each pixel's colour in the change map determines the editing level of the corresponding pixel in the input image. If a pixel in the change map has a value of 1.0 (i.e., pure white), the corresponding pixel in the input image is non-editable. Alternatively, if a pixel in the change map has a value of 0.0 (i.e., pure black), the corresponding pixel in the input image is completely editable. Pixel values between 0.0 and 1.0 make corresponding pixels in the input image semi-editable. This allows for smooth transitions between editable and non-editable areas-thereby allowing the system to generate more realistic images.

As the mask image 1000 generated at step 406 has two pixel values—i.e., one value for the masked portions 1002 and another for the highlighted portions 1004, if this mask image 1000 were used as is for generating the new background, it may cause the background to abruptly end when any white pixels are encountered (e.g., in the highlighted portions 1004). This may cause the overall design to appear unprofessional.

To overcome this issue, in some embodiments, the mask is refined at step 408. In particular, the mask image 1000 is forwarded to the mask refiner 115 at this step. The mask refiner 115 applies blurring non-white pixels in the mask image 1000 using a Gaussian kernel of size k. The size of the kernel (k) controls the level of visual striking of the text regions in the final designs. A low kernel size makes the level of visual striking of the text regions higher, whereas higher kernel sizes make the level of visual striking of the text regions lower. Any suitable kernel size may be selected depending on the required level of visual striking required in the final design. In one example, the kernel value can be set to 10—i.e., the pixel values of a 10×10 matrix around any given pixel is used to determine the new value for that pixel. Further, the starting pixel values of the highlighted portions 1004 and the masked portions 1002 may be set to any suitable pixel values in this step. In one example, the starting pixel values for the highlighted portions 1004 is set as 0.6 and the starting pixel values for the masked portions 1002 is set as 0.2 respectively. A Gaussian blur is then applied to the mask image 1000.

FIG. 11 illustrates an example refined mask image 1100. As pixels in the masked portion will typically be surrounded by other pixels that have the same pixel values, the Gaussian blur does not change those pixel values. However, as pixels in the boundary regions between the masked and highlighted portions will have pixels with different values, the values of pixels in these regions will be changed based on the Gaussian function. This can be seen from the blurring of the boundaries between the highlighted and masked portions. Pixels in the blurred portions 1104 have intermediate pixel values. It will be appreciated that Gaussian blur is one technique for generating the refined mask image 1100 and other blurring techniques can be utilized to generate the refined mask image 1100 without departing from the scope of the present disclosure.

Next, at step 410, the background prompt generator 114 generates one or more background prompts based on the user input prompt present in the design plan descriptor 127. The background prompt is utilized to generate the new background subsequently. Accordingly, at this step, the background prompt generator 114 analyses the user input prompt to generate a prompt that would be suitable for generating the background of the design. For example, consider the user input prompt, “illustrative, underwater coral-reef themed Instagram post”. The background prompt generator 114 may analyse this input prompt and generate a background prompt such as “Undersea scene with fish and coral reef”. In doing so, the background prompt generator 114 may initially remove any non-background details from the user input prompt (e.g., doctype intentions such as Instagram post) and determine the intent of the remainder of the user input prompt.

In some embodiments, the background prompt generator 114 is a small language model that is trained for this task. As compared to large language models, small language models have fewer parameters-therefore requiring less computational power and memory. Further, these models are generally faster than large language models in generating outputs due to their smaller size. Like larger models, small language models are initially trained on large datasets to learn linguistic patterns, grammar, and general knowledge. They can subsequently be fine-tuned for specific tasks.

One such smaller language model is Falcon-1B, which has 1 billion parameters. It is a causal decoder-only model that includes layers of self-attention mechanisms that allow the model to weigh the importance of the different words in an input sequence to understand context. It generates output text by predicting the next word in a sequence based on previous words.

To fine-tune the small language model to generate background prompts based on user inputs, a large number of training samples that include the user input and desired background prompt are fed to the small language model until the model learns to output the desired background prompt for a given user input with accuracy (e.g., 90-95% accuracy). As an example, the smaller language model (e.g., Falcon-1B) maybe fine-tined using LoRA (Low-Rank Adaption) fine-tuning. In some examples, the model may be trained to output multiple background prompts for a given user input.

In another embodiment, the background prompt generator 114 is a specific ML model that is specifically trained to perform the task of analyzing an input prompt and generating a background prompt. In this case, the background prompt generator 114 may be fed copious amounts of training data initially to train it—e.g., it may be provided a large number of sets of input prompts and output background prompts (e.g., hundreds of thousands of input/output labelled training data samples). The background prompt generator 114 may be trained on this data until it can accurately generate the expected background prompt for a given input prompt most of the time. Then, at execution time, an input prompt may be provided to the trained background prompt generator 114 and it outputs the background prompt.

In other cases, the background prompt generator 114 may communicate with a pre-trained generalized large language ML model (that can perform any language-based task). An example of such a large language model is ChatGPT. The ML model in ChatGPT is trained on vast amounts of text data, such as books, articles, and other written works. This data is used to teach the model how to recognize patterns and relationships between words and phrases, and how to generate new text that sounds natural. Once the model has been trained on this data, it can be used to generate new text in response to any user input. As a generalized ML model of this type may not know the specific task of converting an input prompt into a background prompt, the background prompt generator 114 may provide a small amount of training data (e.g., 10-20 samples of input prompts and background prompts) along with specific instructions (e.g., provide 3-4 words to represent commonly observer elements or themes associated with the requested design. If the design request includes style or color related terms, incorporate such terms in the response) in order to quickly teach the ML model to output the expected background prompt for the given input prompt.

In the case of the pre-trained large language model, in some embodiments, the training data may be stored in the data store 120 and the background prompt generator 114 may provide this to the model each time step 410 is executed—i.e., with each new request. In other embodiments, the training data may be provided once per session with the ML model. The training data is not required with each new request in this embodiment as long as an active session is maintained with the ML model. Once the session ends, the training data may be provided to the machine learning model again when a new session is initiated.

At step 410, the user input prompt is provided to the background prompt generator 114. In case this module is a specifically trained ML model or a small language model, it returns the background prompt. Alternatively, if a large language model (e.g., ML system 130) is used, the background prompt generator 114 may first generate a request prompt for the ML system 130. This request prompt may be a concatenation of the user input prompt, training samples, and configuration data (e.g., definition of the task and parameters for the task). The request prompt is then fed to ML system 130. The ML system 130 generates the background prompt and communicates it to the background prompt generator 114.

The background prompt generator 114 then updates design plan descriptor 127 to include the background prompt. An example design plan descriptor 127 at this stage is displayed below in table F—

TABLE F
Example design plan descriptor after step 410

| | |
|---|---|
| Design plan | 273278 |
| identifier | |
| User prompt | “Illustrative, underwater coral-reef |
| | themed Instagram post” |
| Seed design | abc123 |
| template ID | |
| Background | Undersea scene with fish and coral |
| prompt | reef |

At step 412, the background generator 117 generates a new background based on the background prompt, the background 910 and the mask image 1000 (or the refined mask image 1100). Various suitable techniques may be employed to generate the new background.

In some embodiments, the background generator 117 utilizes an in-painting technique to generate the new background. According to this technique, regions of the design template 900 that are masked in the mask image 1000 are changed based on the background prompt, whereas the regions of the seed design template 900 that are highlighted in the mask image 1000 remain unchanged. In particular, the background generator 117 stylizes the masked portions 1002 of the seed design template 900 based on the background prompt. To do so, the background generator 117 is trained to refine the stylization of the masked portions by making sure they align with the background prompt.

In particular, the background generator 117 generates design objects that fill the space within the masked portions 1002 based on the background prompt. For example, if the background prompt is “Undersea scene with fish and coral reef”, the background generator 117 may render a suitable design of an undersea scene that includes coral reef and different types of fish in the masked portion 1002. It may take into consideration the size and shape of the masked portion 1002 in doing so. Further, it may generate the scene and/or a background colour that is indicative of a style mentioned in the background prompt (if available)—e.g., colours or painting techniques that are reminiscence of the mentioned style.

In-painting techniques usually work with a binary mask, e.g., mask image 1000—i.e., having black and white pixel values. The black pixels are painted with the background, whereas the white pixels remain unchanged. Although this may be suitable in some cases, it may result in subpar designs in other cases. For example, consider the scenario where the background prompt is, “ocean blue undersea scene with colourful fish and coral reef” and the mask image is as shown in FIG. 10. In this case, the background generator 117 may in-paint all the black pixels with colourful fish and coral reef. However, some of the fish and/or coral reef may be abruptly cut-off or be incomplete at the mask pixels that border the highlighted portions 1004. This may result in unrealistic backgrounds.

To address this, in other embodiments a differential diffusion technique may be employed by the background generator 117. Typically, diffusion models are trained to recover an input image from noise—that is, a diffusion model is initially provided an input image, and it gradually adds noise to the image in a forward diffusion process-creating a series of intermediate images, where each intermediate image is the result of the denoising operation of the previous intermediate image. The model is then trained to recover the input image from the noise by reversing the diffusion process. The model is trained to do so on many images, such that starting from random noise, it can generate new data. The result is that these ML models are generally able to generate high-quality images based only on input text prompt. The quality of the images may depend on the number of backward diffusion steps the ML model takes to generate the new data. Some examples of diffusion models include DALL. E 2, Stable Diffusion, and Midjourney.

Some diffusion models allow in-painting as described above. However, in such systems, the change is applied uniformly to all masked portions 1002 of an input image and are not applied to the highlighted portions 1004 of the masked image. A differential diffusion model on the other hand adds the ability to control the amount of change applied to each image region according to the pixel values in the refined mask image 1100. The higher the pixel value (i.e., closer to white), the lower the amount of change applied and the lower the pixel value (i.e., closer to black), the higher the amount of change applied. If the pixels in the boundary region between the masked and highlighted regions have intermediate values between black and white pixel values, the differential diffusion model is able to apply change to these pixels by a lower amount than that applied to the masked portions 1002 but higher than the amount of change applied to the highlighted portions 1004. This controlled change in the boundary regions allows the background generator 117 (that implements a differential diffusion model) to generate backgrounds that have smoother transitions in the border regions, thereby generating superior quality backgrounds and overall designs.

To generate the background, the background generator 117 decomposes the refined mask image 1100 into a series of nested masks that are applied iteratively, such that each region begins the inference at a different timestep according to the mask. In particular, first, the original background 910 is encoded to a latent space (zᵢₙᵢₜ), and the map is down-sampled to the latent space spatial dimensions. Due to locality, the down-sampled map (μs) aligns with the positions of the latent pixels in the latent tensor. The denoising loop is changed for each time step/as follows. Initially the encoded original background image 910 is noised according to a current timestep (z′t). Then, a mask is calculated of all points which are lower than a threshold (k−t/k) in the refined mask. K−t/k is the value of the complement of the strength (that determines the amount of change applied by the edit). Therefore, the pixel values of the refined mask image 1100 determine the last timestep where each region is overridden, controlling the amount of change of the region, due to a suffix principle (where for every complete image-to-image inference chain Σ, every suffix σ is also an inference chain. Let N,n be the number of timesteps of Σ,σ, the noise levels in σ's intermediate images match those of an inference chain, with a strength of n/N).

The masks are nested; therefore some regions are copied from the noised original background image 910 multiple times, in contrast to copying each region once according to its strength. This mimics the distribution it has been trained on and gives it an advance knowledge of the content of lighter regions.

Next, all the selected regions in the mask image 1000 from the previous timestep are copied. The rest is copied from the noised version of the original background image 910. This is possible due to an overridability principle (which states that regions in the intermediate images can be overridden by external content with the same distribution and influence the generated image without breaking the inference process). Finally, the background generator 117 denoises the result (z^{mix}ₜ). After the loop, z₀ is decoded to the pixel space, yielding the result (x_{cap}).

FIG. 12 illustrates an example new background generated based on the original background 910, the mask image 1000 (or the refined mask image 1100), and the background prompt shown in table D.

Method 400 ends once the new background is generated at step 412. The new background image may be saved in data storage in association with a unique background identifier. Further as described previously, the unique background identifier is added to the design plan descriptor at this stage.

It will be appreciated that in method 400 either the mask image 1000 or the refined mask image 1100 is used along with the background 910 to generate the new background. In other embodiments, the new background can be generated without the use of a mask or a background image. In such examples, the new background is generated based simply on the background prompt. In such embodiments, a seed design template may not be required, and method steps 402-408 may be omitted. Instead, a background prompt is generated based on the user input using step 410 and that background prompt is utilized to generate the new background. In such cases, the background generator 117 is modified and may use a different technique for generating the new background. For example, it may utilize a diffusion model without any in-painting, similar to diffusion model systems such as Stable Diffusion, Dall-E, etc. These types of diffusion models use a text input query to generate the background.

Further still, in some embodiments, the new background 1200 may be generated without requiring the background prompt. In such cases, the new background 1200 may be generated based on the user input prompt instead of the background prompt. In case in-painting models are used, the new background may be generated in such embodiments based on the background 910, the mask image 1000 and the user input prompt. In case a diffusion model (without in-painting) is used, the user input prompt may be utilized by itself to generate the new background 1200. Alternatively, in case of differential diffusion, the user input prompt may be utilized along with the refined mask image 1100 and the background 910.

FIG. 6 illustrates an example method 600 for performing step 308 (i.e., generating text content). In some embodiments, the text content may be generated as replacement text for placeholder text elements, for example, in the seed design template in the design plan descriptor. To so do, the method 600 commences at step 602, where the text generator 116 retrieves design template metadata from the metadata library 123. In particular, it may retrieve the value fields in the metadata record corresponding to the design template and the placeholder text elements.

At step 604, the text generator 116 uses the retrieved design template metadata along with the user input prompt to generate a text content prompt.

In some examples, the text content prompt includes configuration data and prompt data. The configuration data may include a brief description of the task (e.g., to generate text content for a design), parameters for the task (e.g., output format, tone of the output, rules, etc.), and one or more training examples of input prompts and the text content the ML system 130 is expected to generate based on the input prompts.

The table G below shows examples of configuration data that can be used.

TABLE G
Example design outline configuration data

| | |
|---|---|
| Description of task: | Generate replacement text content for a design given an input |
| | query and a set of fields to populate values for. |
| Parameters: | The set of fields will be in the form “key$$$ <metadata |
| | describing the field>”. |
| | The output must be formatted as: “key$$$ <field value> |
| | For titles, assume few words. for paragraphs assume at least 25 |
| | words. |
| | The prompt may include information about the goal of the |
| | design, it is in the form design: <context>. Use this to create |
| | relevant responses. |
| Examples: | Example 1 |
| | Input query: A nice presentation for my dog. |
| | Design: A title page of the presentation |
| | text1.2$$$title for the slide |
| | text2.X$$$name of presenter |
| | text3.3$$$fun dog fact |
| | image1.2$$$hero image |
| | Desired output |
| | text1.2$$$My wonderful dog |
| | text2.X$$$By [name here] |
| | text3.3$$$Dogs have best friends! |
| | Image1.2$$$happy dog |
| | Example 2 |
| | Input query: A pitch deck presentation for my lawn care |
| | business. |
| | Design: A page outlining details |
| | text1.X$$$The title of the page |
| | text2.X$$$A description of the product |
| | text3.3$$$A tagline under a logo |
| | image1.X$$$a logo of business |
| | Desired output |
| | text1.X$$$Clipping into business |
| | text2.X$$$We are excited to launch a fresh new business all |
| | about cutting lawns in the local neighbourhood |
| | text3.1$$$Beautiful grass always |
| | image1.X$$$lawn mower |

It will be appreciated that the configuration data may include many alternative components. For example, the configuration data may be (or include) a single pre-assembled template prompt—e.g. a string that includes all the relevant set text components.

In one example, the parameters of the configuration data may be different for different types of placeholder text elements. For example, if a placeholder text element is of a ‘heading’ type and another placeholder text element is of a ‘body’ type, the specific text format required for each of these element types may be different. Accordingly, in some embodiments, the text generator 116 identifies the placeholder text element types for each design template from the metadata and updates the configuration data such that the parameters section of the configuration data matches the placeholder text element types for that design template.

Further, as the length(s) and type(s) of text content may be different for different types of placeholder text elements, any number of words, characters, sentences or bullet points may be suitably specified in the configuration data. The types of few-shot examples provided may also be varied depending on the type of placeholder text element present in the seed design template.

Returning to method step 604, once the text generator 116 receives the design template metadata, it identifies the placeholder text element types required for the seed design template (e.g., by inspecting the corresponding metadata) and then updates the parameters of the configuration data based on the identified placeholder text element types.

The text generator 116 then generates the design content prompt. To do so, it combines the user input prompt and the metadata with the updated configuration data.

At step 606, once the design content prompt is generated, the text generator 116 communicates the design content prompt to the ML system 130.

By way of the text content configuration data, the ML system 130 is cued to generate text content based, in part, on the user prompt, metadata and the parameters of the configuration data. For example, based on the example configuration data shown in table G, the ML system 130 may be cued to generate different types of text content (e.g., text1, text2, etc.) of different structure and text length. The ML system 130 outputs the text content in accordance with the corresponding design content prompt.

At 608, the design content output by the ML system 130 is received by the text generator 116 as a string of output text, referred to as a completion. The text generator 116 updates the design plan descriptor with the received text content.

At step 610, the text generator 116 processes the completion, which may include analysing the completion to identify the respective text elements expected according to the template metadata. For example, the text generator 116 may parse or process the output text to identify a string of text following the appearance of “$$$” as defined by the output format of the text in the configuration data. Additionally or alternatively, text content may be identified according to line breaks, carriage returns and/or special characters as may be defined in the configuration data. Many alternative parsing, text analysis and processing techniques are also possible to identify the text elements in the completion.

At step 612, the text generator 116 stores the identified text elements in the design plan descriptor. For example, the text elements may each be stored as a text element record having text content and a text hierarchy level. The text elements may map to a template ID of the corresponding seed design template from which the template metadata and placeholder text was used to generate the respective text elements. In some embodiments, the text elements may be stored as respective text content data (and metadata) of respective design templates in the design plan descriptor. The method 600 then ends.

It will be appreciated that in method 600, it is presumed that the configuration data is provided to the ML system 130 each time new design content is required. However, this need not be the case in all implementations. In other implementations, the design content configuration data may be provided to the ML system 130 each time an instance of the ML system 130 is invoked. If the same ML system instance is then used for subsequent design content requests, the configuration data need not be re-submitted to the ML system 130 as the ML system 130 can remember the configuration data it has been provided previously and utilize that configuration data for subsequent design content requests. Once the ML system instance is closed or exited, it may flush the configuration data and the text generator 116 may need to resend the configuration data along with a design request when a new instance of the ML system 130 is invoked.

Further still, it is presumed that the ML system 130 is a general purpose LLM that has not previously been trained or configured to provide design content in the required manner. However, this need not be the case in all implementations. In some implementations, a specific purpose ML system may be adopted that has been trained using copious amounts of training data of design types, text content metadata and user prompts and desired output design content. There is no need to provide additional configuration data for such specifically trained ML systems 130 and in such cases, the design content prompt may simply include the user prompt and design metadata.

Referring now to FIG. 7, a method 700 for generating and outputting the final design is described. Method 700 will be described with reference to generating and outputting a single design.

At 702, the renderer 118 retrieves the design plan descriptor 127 and the seed design template record.

At 704, a new design record is generated. The design record may be assigned a new unique identifier. The dimensions and other design information (such as style and type) for the design record may be copied from the seed design template. Other fields such as the design name can be either populated with a default value or based on the received user prompt received. The design owner can also be populated based on the identifier of the use that requested the design. Style attributes can be copied from the seed design template record. The background field of the design record is updated to include the background identifier from the design plan descriptor and the element data field(s) or element records are updated based on the text content from the design plan descriptor and the design template record. That is, the styling of the text elements, such as font type, font size, font colour, hierarchy, and position can be copied from the corresponding text elements of the seed design template, whereas the text element content fields can be updated based on the corresponding text content from the design plan descriptor.

At step 706, the renderer 118 saves the new design record using a unique identifier in the data store 120 (e.g., in designs library 126). Further, the renderer 118 communicates the design record to the client application 142. At this stage, the design plan descriptor 127 may be discarded.

The client application 142 may then render the design for display on a UI on the client system 140 using the design record. For example, the client application 142 may generate a rasterized image of the design based on the design record.

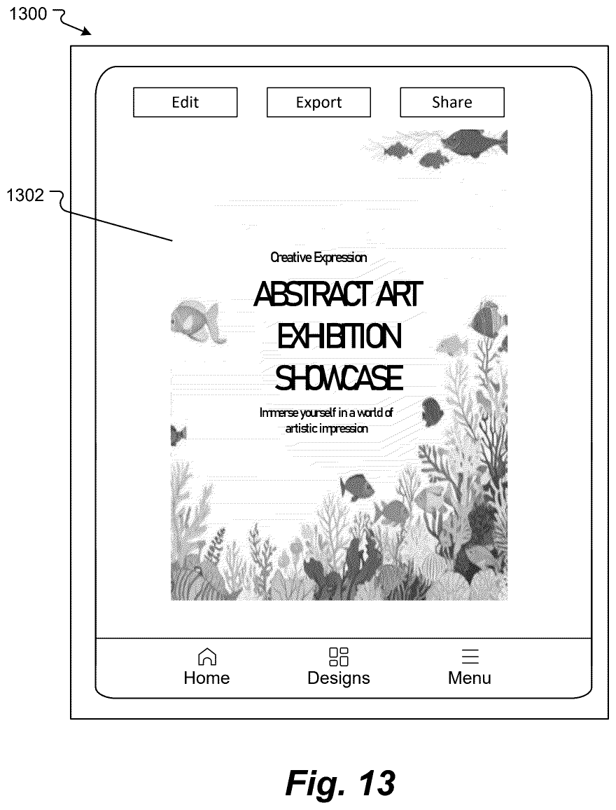

FIG. 13 shows an example UI 1300 generated and displayed on the client system 140 at the end of method 700. In this example, the UI 1300 displays a design 1302 generated by the system 110 in response to the user input received in UI 800.

Once the design 1302 is displayed, the user may also be provided edit functionality within the UI 1300 to edit selected design elements in the design. Editing functionality may include, for example: adding an element to the design; removing an element from the design (including removing elements that have been automatically generated for the design); editing an element that has been added to the design (including editing the elements that have been automatically generated for the design); and/or other operations.

UI 1300 may also provide a user with various options for exporting the output design. This may include, for example, one or more options that allow a user to: determine an export location (e.g. on local memory such as 210 or a network accessible storage device); determine an export format (e.g. a file type); determine an export size/resolution; and/or other export options.

UI 1300 may further provide a user with various options to share the design. This may include, for example, one or more options that allow a user to determine a format (e.g. file type) and then share the resulting design (e.g. by attaching it to an electronic communication, uploading to a web server, uploading to a social media service, or sharing in an alternative manner). Application 142 may also provide a user with the option of sending a link (e.g. a URL) to the design (e.g. by generating a link and attaching a link to an electronic communication or allowing a user to copy the link).

### OTHER EMBODIMENTS

In methods 300-700, the application 112 generates a single design in response to the user input. It will be appreciated that the application 112 can be configured to generate multiple candidate designs. Multiple candidate designs can be generated using suitable techniques to generate variations in the output designs. For instance, the server application 112 may retrieve multiple seed design template records at step 402. In some examples, user may select multiple seed design templates via UI 800. In other examples, the server application 112 may supplement a user selected seed design template or the automatically selected seed design template with other seed design templates automatically. This may be done in a similar manner as selection of the first seed design template discussed above. In this example, new backgrounds may be created for each of the seed design templates using method 400 and these new backgrounds are used in method 700 to generate the multiple candidate designs.

In another instance, a single seed design template may be employed, but the background prompt generator 114 may generate multiple background prompts that are slightly varied. These different background prompts may be used along with the same seed design template background and mask to generate different backgrounds.

In still another instance, the non-deterministic nature of the background generator 117 may be utilized to generate multiple background. In this case, a single seed design template and background prompt are used along with the mask, but step 412 is repeated multiple times. Each time, the background generator 117 generates a new background that is different from previously generated backgrounds.

In some examples, the same text content may be used across the same text hierarchy level text elements of each design template. That is, all the candidate designs may have the same text content. In other examples, different text content may be generated and populated in each candidate design. If a single seed design template is used, this may be done by passing the same design content prompt to the ML system 130 repeatedly. Due to the non-deterministic nature of the ML system 130, the ML system generates slightly different content for each repetition. If multiple seed design templates are used, different design content prompts are generated (as the metadata for the seed design templates may vary) and communicated to the ML system 130. The ML system 130 then generates text content for each of the different design content prompts.

Further still, although methods 300-700 describe that style attributes such as colour, font, font size are the same as the default colour, font, and font size of the seed design template. However, this need not be the case in all implementations. In some cases, the font, font size, and/or font colour may be selected during the design process.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

In the embodiments described above, the operations of methods 300, 400, 500, 600, and 700, are described as being performed by application 112 (and the various associated modules) running on a single computer processing system. The operations could, however, be performed by one or more alternative applications running on system 110 and/or one or more alternative computer processing systems. For example, one or more of modules 113-118 may be distinct applications (running on the same or separate computer processing systems) that interoperate with application 112 to perform the described techniques. In another example, the functions performed by modules 113-118 may be combined together in a design generation service that can be accessed by any appropriate application (e.g. a web browser or other application). In another example, the functionality of modules 113-118 may be provided by one or more client-side applications. In this case, application 142 may be configured to perform the relevant operations (e.g. those of modules 113-118) for generating a design.

As yet another example, the functions performed by modules 113-118 may be combined together in a design generation package that can be used to extend the functionality provided by any design production application. In this case the design generation package may be locally installed on a given end user system, e.g. as a plug-in or extension to an existing video production application.

In the above description, certain operations and features are explicitly described as being optional. This should not be interpreted as indicating that if an operation or feature is not explicitly described as being optional it should be considered essential. Even if an operation or feature is not explicitly described as being optional it may still be optional.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In certain instances the present disclosure may use the terms “first,” “second,” etc. to describe various elements. Unless stated otherwise, these terms are used only to distinguish elements from one another and not in an ordinal sense. For example, a first element or feature could be termed a second element or feature or vice versa without departing from the scope of the described examples. Furthermore, when the terms “first”, “second”, etc. are used to differentiate elements or features rather than indicate order, a second element or feature could exist without a first element or feature. For example, a second element or feature could occur before a first element or feature (or without a first element or feature ever occurring).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

Background information described in this specification is background information known to the inventors. Reference to this information as background information is not an acknowledgment or suggestion that this background information is prior art or is common general knowledge to a person of ordinary skill in the art.

1. A computer implemented method for automatically generating a design, the method including:
receiving an input prompt for generating the design;
generating a design background based at least on the input prompt and a seed design template;
generating design text based at least on the input prompt;
generating a design record including an identifier of the generated design background and the generated design text; and
causing the design to be displayed on a client device, the design rendered based on the design record.

2. The computer implemented method of claim 1, wherein generating the design background includes:
generating a background prompt from the input prompt, the background prompt representing an intent for the design background; and
generating the design background based at least on the background prompt.

3. The computer implemented method of claim 2, wherein the background prompt is generated by a small language model, or a diffusion model.

4. The computer implemented method of claim 1, wherein generating the design background includes:
decomposing the seed design template into a background component and overlaying text elements; and
generating a mask image from the seed design template, wherein the mask image comprises masked portions representing background component pixels and highlighted portions representing overlaying text element pixels; and
generating the design background based at least on the mask image, and the background component.

5. The computer implemented method of claim 4, further comprising generating a background prompt from the input prompt, the background prompt representing an intent for the design background and wherein generating the design background is further based on the background prompt.

6. The computer implemented method of claim 4, wherein the design background is generated using an in-painting based diffusion model or a differential diffusion model.

7. The computer implemented method of claim 1, wherein generating the design background includes:
decomposing the seed design template into a background component and overlaying text elements; and
generating a mask image from the seed design template, wherein the mask image comprises masked portions representing background component pixels and highlighted portions representing overlaying text element pixels, the background component pixels having a first pixel value and the highlighted portions having a second pixel value;
refining the mask image by applying a blur function such that at least a portion of the first pixel values and at least a portion of the second pixel values are converted into intermediate pixel values having one or more pixel values between the first pixel values and the second pixel values; and
generating the design background based on at least the refined mask image, and the background component.

8. The computer implemented method of claim 7, further comprising generating a background prompt from the input prompt, the background prompt representing an intent for the design background and wherein generating the design background is further based on the background prompt.

9. The computer implemented method of claim 7, wherein the design background is generated using a differential diffusion model.

10. The computer implemented method of claim 4, wherein generating the mask image comprises:
replacing a background element in a record of the seed design template with a solid fill having a first colour;
modifying a text colour of the text elements in the record of the seed design template with a second colour that is in contrast to the first colour;
applying a background effect to the text elements in the record of the seed design template using the second colour; and
generating a rasterized image using the modified record of the seed design template.

11. The computer implemented method of claim 7, wherein refining the mask image includes applying a Gaussian blur of a predetermined kernel size to the mask image.

12. The computer implemented method of claim 1, wherein generating the design text based at least on the input prompt comprises:
retrieving the input prompt;
generating a text content prompt, the text content prompt including the input prompt and configuration data to configure a machine learning system to generate the text content;
communicating the text content prompt to the machine learning system configured to generate the text content based on the text content prompt.

13. The computer implemented method of claim 1, wherein generating the design text based at least on the input prompt comprises:
retrieving the input prompt and metadata associated with the seed design template;
generating a text content prompt, the text content prompt including the input prompt and the metadata associated with the seed design template;
communicating the text content prompt to a machine learning system configured to generate the text content based on the text content prompt.

14. The computer implemented method of claim 13, wherein the text content prompt further includes configuration data to configure the machine learning system to generate the text content, wherein the configuration data includes one or more few-shot training examples.

15. The computer implemented method of claim 13, wherein the metadata associated with the seed design template includes:
metadata that semantically describes text elements in the seed design template; and/or
a textual description of the seed design template.

16. The computer implemented method of claim 1, wherein generating the design record comprises:
retrieving a record of the seed design template;
copying values for one or more fields from the seed design template;
adding an identifier of the design background; and
adding values of the generated text content.

17. The computer implemented method of claim 16, wherein generating the design record further comprises copying style attributes of the text elements from the record of the seed design template.

18. The computer implemented method of claim 1, wherein an identifier of the seed design template is received along with the input prompt, or the seed design template is automatically selected.

19. A computer processing system including:
one or more computer processing units; and
non-transitory computer-readable medium storing instructions which, when executed by the one or more computer processing units, cause the one or more computer processing units to:
receive an input prompt for generating the design;
generate a design background based at least on the input prompt and a seed design template;
generate design text based at least on the input prompt;
generate a design record including an identifier of the generated design background and the generated design text; and
cause the design to be displayed on a client device, the design rendered based on the design record.

20. A non-transitory storage medium storing instructions executable by one or more computer processing units to cause the one or more computer processing units to:
receive an input prompt for generating the design;
generate a design background based at least on the input prompt and a seed design template;
generate design text based at least on the input prompt;
generate a design record including an identifier of the generated design background and the generated design text; and
cause the design to be displayed on a client device, the design rendered based on the design record.
